(19) United States
(12) Patent Application Publication
(10) Pub. No.: US 2017/0004557 A1
(43) Pub. Date: Jan. 5, 2017

(54) DATA RECOMMENDATION AND PRIORITIZATION

(71) Applicant: eBay Inc., San Jose, CA (US)

(72) Inventors: Dane Glasgow, Los Altos, CA (US); Matthew Bret MacLaurin, Santa Cruz, CA (US); David Ramadge, San Jose, CA (US); Corinne Elizabeth Sherman, San Jose, CA (US); Anthony Shah, Santa Clara, CA (US); Theodore James Dziuba, San Mateo, CA (US); Josephine Pang, San Francisco, CA (US)

(21) Appl. No.: 14/790,027

(22) Filed: Jul. 2, 2015

(51) Int. Cl. G06Q 30/06; G06F 3/0484; G06F 3/0482; G06F 17/30

(52) U.S. Cl. CPC G06Q 30/0631; G06F 17/30867; G06F 17/30601; G06F 17/30554; G06F 3/04842; G06F 3/0482

(57) ABSTRACT

In various example embodiments, a system and method for generating recommendations for data and prioritizing data based on the recommendations are presented. The system accesses an item listing including an item description and determines the item listing is a candidate for a recommendation label. The system receives a recommendation indication for the item listing. The recommendation indication represents a recommendation for the item listing between a first price and a second price. In response to the recommendation indication, the system associates a recommendation tag with the item listing and causes presentation of the item listing with a representation of the recommendation tag.

### TECHNICAL FIELD

Embodiments of the present disclosure relate generally to data processing and, more particularly, but not by way of limitation, to generating recommendations for data and prioritizing data based on recommendations.

### BACKGROUND

Conventionally, a user researching unfamiliar items in a new category must parse varying information sources in order to locate useful information regarding the items. Researching unfamiliar items often benefits from expert recommendations and reviews of items. However, it takes time for users to determine experts within a given category or type of item associated with the unfamiliar item being researched. Further, once the user gains enough knowledge to make an informed decision on the now familiar item or category, that knowledge is often never again needed or needed with such infrequency that the knowledge becomes outdated prior to its next application. In addition to time, the user expends computing resources.

Existing systems can provide functionality to enable contact with self-identified experts or aggregation of expert opinions. The user may then take the information obtained on these existing systems, locate the same or similar product, and then attempt to apply that information to the item.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram of an example recommendation system, according to various embodiments.

FIG. 3 is a flow chart illustrating an example method, according to various embodiments.

FIG. 4 is a flow chart illustrating an example method, according to various embodiments.

FIG. 5 is a flow chart illustrating an example method, according to various embodiments.

FIG. 6 is a flow chart illustrating an example method, according to various embodiments.

FIG. 7 is a flow chart illustrating an example method, according to various embodiments.

FIG. 8 is a flow chart illustrating an example method, according to various embodiments.

FIG. 9 is a flow chart illustrating an example method, according to various embodiments.

FIG. 10 is a block diagram illustrating an example of a software architecture that may be installed on a machine, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments methods and systems described in the application present data recommendation and prioritization functions. In some instances these data recommendation and prioritization functions employ determinations of expertise for recommenders and independent, automatic verification of expertise of recommenders. Some example embodiments of the methods and systems described herein present improvements on existing machines by performing specific functions, described in detail below. In some instances the methods and systems described in the present application provide new functions or combinations of functions not previously performed by existing systems and methods.

In various embodiments, methods and systems for a recommendation system are presented. The recommendation system enables gathering of recommendations and associations of recommendations with discrete data objects within predetermined categories. In some example embodiments, the recommendation system provides automatic identification of users with expertise in one or more categories and associates a recommender status to the users based on the identified level and breadth of expertise. In some instances, the recommendation system solicits recommendations for the discrete data objects from identified recommenders for use in prioritization of the discrete data objects. The prioritization of the discrete data objects may be achieved through generation of displayable user interface elements, reordering predetermined orders or organizational structures for the discrete data objects, removal of discrete data objects from a predetermined order or organizational structure, and combinations thereof, among other prioritization and presentation options.

In some example embodiments, where the recommendation system identifies recommenders, based on identifiable expertise within a category, the recommendation system automatically verifies the expertise of the recommenders and a relative level of the expertise with respect to other identified recommenders within the category. In some instances, the recommendation system precludes recommender interaction with the discrete data objects once the recommender has provided a recommendation. Further, in some example embodiments, the recommendation system incentivizes review and recommendation of discrete data objects. The recommendation system may also perform functions to preclude abuse of the incentives and status as a recommender.

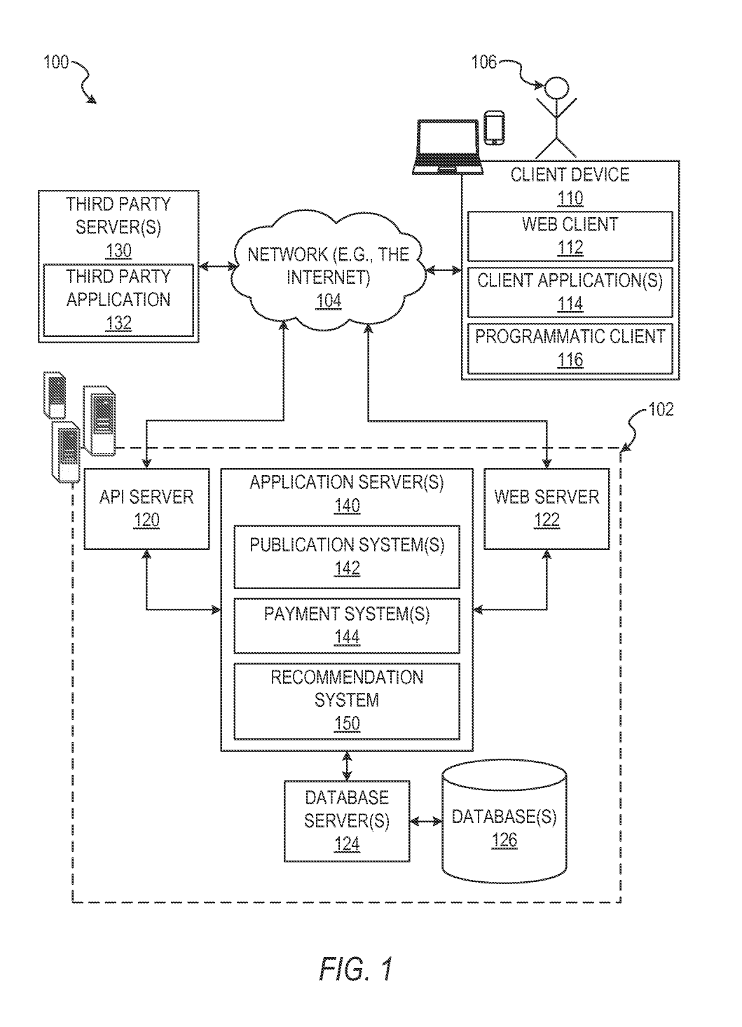

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based marketplace that responds to requests for product listings, publishes publications comprising item listings of products available on the network-based marketplace, and manages payments for these marketplace transactions. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

A recommendation system 150 may provide functionality operable to solicit recommendations, associate recommendations with discrete data objects (e.g., item listings stored in the publication system 142), and prioritize the discrete data objects based on the recommendations. The recommendation system 150 may also perform various determination and verification operations to determine expertise of one or more users 106 within one or more categories and provide relative rankings of expertise among the one or more users 106. For example, the recommendation system 150 accesses an item listing from the databases 126, the third party servers 130, the publication system 142, and other sources, determines a candidacy of the item listing for recommendation, solicits a recommendation, and uses the recommendation to provision the item listing when the item listing is included in a search query result for a user. In some example embodiments, the recommendation system 150 may determine the expertise of one or more user 106 to apply a recommender status to the one or more user 106 to facilitate recommendations of item listings. As more content is added to a category by the users and more interactions are performed by the users on content within any given category, the recommendation system 150 can further refine the determinations of expertise as well as weights for recommendations from a given recommender for use in provisioning item listings in a prioritized format. In some example embodiments, the recommendation system 150 functions to automatically change user profiles based on application or removal of recommender status as well as automatically modifying item listings based on positive and negative recommendations by recommenders in order to facilitate prioritization. Further, the recommendation system 150 may communicate with the publication systems 142 (e.g., accessing item listings) and the payment system 144. In an alternative embodiment, the recommendation system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and recommendation system 150 could also be implemented as standalone software programs, which do not necessarily have networking capabilities.

The web client 112 may access the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

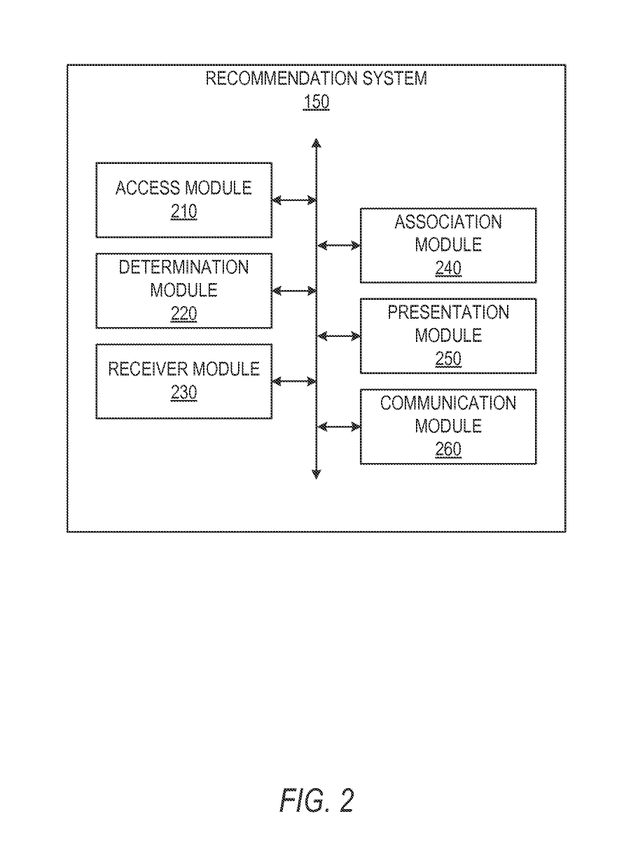

FIG. 2 is a block diagram illustrating components of the recommendation system 150, according to some example embodiments. The recommendation system 150 is shown as including an access module 210, a determination module 220, a receiver module 230, an association module 240, a presentation module 250, and a communications module 260, all configured to communicate with one another (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform operations for which that module is designed. Moreover, any two or more of these modules may be combined into a single module, and the functions described herein for a single module may be subdivided among multiple modules. Furthermore, according to various example embodiments, modules described herein as being implemented within a single machine, database(s) 126, or device (e.g., client device 110) may be distributed across multiple machines, database(s) 126, or devices.

The access module 210 accesses discrete data objects within the publication system 142. The discrete data objects include characteristics and descriptive data indicative of real world and digital objects, applicable categories for organization within the publication system 142, metadata, and other information suitable for searching, retrieving, prioritizing, and interacting with the discrete data objects. The access module 210 may perform one or more access functions in conjunction with the communication module 260, described in more detail below. The access module 210 may transmit (e.g., via the communication module 260) instructions to one or more of the client device 110, the publication system 142, and the third party servers 130 to access discrete data objects. One or more of the instructions may cause the publication system 142 to retrieve and transmit the discrete data object to the access module 210 for use by the recommendation system 150. The access module 210 can be a hardware implemented module, a software implemented module, or a combination thereof. An example embodiment of components of the access module 210 is described with respect to the module described below in the section entitled “Modules, Components, and Logic.”

The determination module 220 determines whether to instantiate functions of the recommendation system 150 based on data included within or associated with the discrete data objects and profiles of the one or more user 106, stored within one or more of the publication system 142 and the third party servers 130. In some example embodiments, the determination module 220 determines whether the discrete data object is a candidate for a recommendation label. In some instances, the determination module 220 automatically performs one or more functions to facilitate determining candidacy of the discrete data object. Further, the determination module 220 performs operations relating to determinations of the one or more users 106 as recommenders based on an evaluated expertise and evaluated relative expertise with respect to other of the one or more users 106. The determination module 220 can be a hardware implemented module, a software implemented module, or a combination thereof. An example embodiment of components of the determination module 220 is described with respect to the module described below in the section entitled “Modules, Components, and Logic.”

The receiver module 230 receives recommendation indications for the discrete data objects. The recommendation indications are received from recommenders determined to have at least a threshold level of expertise with respect to the discrete data object or a category within which the discrete data object is categorized. The recommendation indication may be representative of a recommendation for the discrete data object based on one or more determined or predetermined characteristics or contingencies, as will be explained in more detail below. The receiver module 230 can be a hardware implemented module, a software implemented module, or a combination thereof. An example embodiment of components of the receiver module 230 is described with respect to the module described below.

The association module 240 associates a recommendation tag with the discrete data object in response to the recommendation indication received by the receiver module 230. The recommendation tag may be understood as a bit, collection of bits, code portion, executable instruction, or other portion of the discrete data object manipulated to enable identification of the discrete data object as being recommended by a recommender and enabling prioritization of the discrete data object. In some embodiments, the recommendation tag may be understood as a binary tag representing either presence or absence of a recommendation. In some example instances, the recommendation tag presents a set of recommendation data. For example, the recommendation tag may indicate presence or absence of a recommendation, a relative strength of the recommendation, one or more conditions applicable to the recommendation, a prioritization weight or relative prioritization weight, or any other information suitable to convey a recommendation and aspects of the recommendation to the recommendation system 150. The association module 240 can be a hardware-implemented module, a software-implemented module, or a combination thereof. An example embodiment of components of the association module 240 is described with respect to the module described below in the section entitled “Modules, Components, and Logic.”

The presentation module 250 causes presentation of discrete data objects (e.g., the item listing) with a representation of the recommendation tag. For example, the presentation module 250 can generate a set of user interface elements, screens, frames, or the like for presentation at the client device 110. In at least some embodiments, the presentation module 250 can cause presentation of the discrete data object (e.g., the item listing) on the user interface of the client device 110 among other discrete data objects (e.g., a set of item listings retrieved as a result set for a search). The presentation module 250 can cause presentation of the discrete data object by transmitting the discrete data object to the client device 110. The presentation module 250 may be implemented within the publication system 142 in the context of a portion of an application or a portion of framework/middleware capable of communicating the discrete data object to the client device 110. The presentation module 250 can be a hardware implemented module, a software implemented module, or a combination thereof. An example embodiment of components of the presentation module 250 is described with respect to the module described below in the section entitled “Modules, Components, and Logic.”

The communication module 260 enables communication between the client device 110, the recommendation system 150, and the publication systems 142. In some example embodiments, the communication module 260 can enable communication among the access module 210, the determination module 220, the receiver module 230, the association module 240, and the presentation module 250. The communication module 260 can be a hardware-implemented module, a software-implemented module, or a combination thereof, as described in more detail below. For example, the communication module 260 can include communication mechanisms such as an antenna, a transmitter, one or more busses, and other suitable communication mechanisms capable of enabling communication between the modules 210-250, the client device 110, the recommendation system 150, and the publication systems 142. The communication module 260 can be a hardware-implemented module, a software-implemented module, or a combination thereof. An example embodiment of components of the communication module 260 is described with respect to the module described below in the section entitled “Modules, Components, and Logic.”

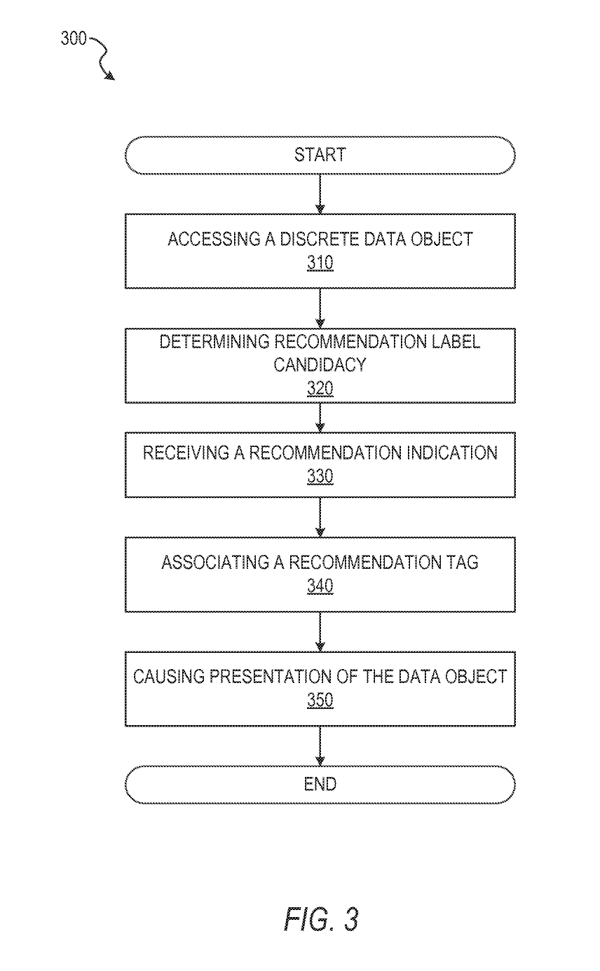

FIG. 3 is a flow chart of operations of the recommendation system 150 in performing a method 300 of automatically ascertaining eligibility of an item listing (e.g., discrete data object) for a recommendation, obtaining the recommendation, and causing prioritization and presentation of the item listing based on the recommendation. Operations in the method 300 may be performed by the recommendation system 150, using modules described above with respect to FIG. 2.

In operation 310, the access module 210 accesses an item listing (e.g., a discrete data object) including an item description. The item listing may be generally understood as a discrete data object configured to convey descriptive information. The item listing may be organizable within a category structure of one or more of the publication system 142 and the third party server 130. In some example embodiments, the item listing may be understood as a saleable item (e.g., a physical real world item, a digital product, a computer readable medium product, a digital representation of a real world item, etc.). For example, the item listing may be an auction listing for sale or soon to be for sale in a timed auction or a live auction. By way of another example, the item listing may be a product listing within a virtual store, or a virtual representation of a physical store, purchasable via the publication system 142 or the third party server 130 over the network 104.

The item listing comprises an item description. In some embodiments, at least a portion of the item description is descriptive data renderable as a human perceivable description containing information about one or more features or characteristics of an item which is the subject of the item listing. In some example instances, a portion of the item description is information not directly presented to the user, but useable by one or more of the publication system 142 and the third party server 130 to organize the item listing within a set of item listings, position the item listing within a ranked or ordered list of the set of item listings, categorize the item listing, and otherwise manipulate a storage location or a presentation of the item listing. Further, in some example embodiments, where the item listing is a saleable item, the item listing additionally comprises a price or other pricing related information. The price may be displayed to users of the publication system 142 upon display of the item listing, or may be hidden from view of the users. The price or pricing related information can be a provisional price or provisional pricing related information subject to change based on one or more functions and received recommendations of the recommendation system 150, as will be explained in more detail below.

In operation 320, the determination module 220 determines whether the item listing is a candidate for a recommendation label, as will be explained in more detail below. In embodiments, where the item listing is determined not to be a candidate for the recommendation label, the item listing may be reevaluated at a later time. Where the determination module 220 determines the item listing is a candidate for a recommendation label, the recommendation system 150 may move to operation 330.

In operation 330, the receiver module 230 receives a recommendation indication for the item listing. For example, after the item listing is determined to be a candidate for the recommendation label, the recommendation system 150 may automatically solicit recommendations for the item listing by transmitting the item listing or a representation of the item listing to one or more users of the publication system 142 determined to have expertise relating to the item represented by the item listing. The recommendation indication represents a recommendation for the item listing from a recommender recognized by the recommendation system 150. The recommendation indication may be included within the item listing as a user interface element selectable by the recommender. For example, the recommendation indication, according to some embodiments, may be an access controlled user interface element (e.g., a toggle, radio button, text field, or other user interface element) accessible only to recommenders having an appropriate expertise or to recommenders to whom the recommendation system 150 provides the item listing.

In some instances, the recommendation indication can be a user generated interrupt configured to cause at least a temporary cessation of one or more processes of the recommendation system 150 and/or the publication system 142, such that the recommendation system 150 is able to modify the item listing in response to the recommendation indication. The modification of the item listing based on the recommendation indication is explained in more detail below with respect to operation 340.

In some embodiments, the recommendation indication is representative of a recommendation of the item listing based on one or more characteristics or contingencies. The characteristics or contingencies may be predetermined by the recommendation system 150 and presented for selection by the recommender (e.g., a set of predetermined price ranges, time ranges, item conditions, etc.). The characteristics or contingencies may also be determined by the recommender, where the recommender includes the condition or contingency in one or more data entry field presented to the recommender at the time the recommender is determining whether to make a recommendation. For example, the recommendation indication may represent a recommendation for the item listing between a first price and a second price, where the first price and the second price are determined either by the recommender or the recommendation system 150. As such, the recommendation indication may be understood, in some embodiments, to be a binary recommendation indication (e.g., recommend or reject) or as having a plurality of selectable or recommender definable options (e.g., recommended within a defined price range during a defined portion of a calendar year).

In some instances, the recommendation may be either a positive recommendation or a negative recommendation (e.g., a rejection). The positive recommendation can be understood to be the recommendation and recommendation indication described above. The negative recommendation is represented by a negative recommendation indication (e.g., a thumb. In this way, the negative recommendation represents a rejection of the item listing in general or based on one or more conditions or contingencies. For example, the negative recommendation may represent a rejection of the item listing between the first price and the second price. In such examples, the negative recommendation may include a corrective condition, indicating a change in condition or contingency that would cause reevaluation of the negative recommendation.

In operation 340, the association module 240 associates a recommendation tag with the item listing in response to the recommendation indication. The recommendation tag may be implemented as a bit, collection of bits, code portions, processor executable instructions, or other portion of the item listing manipulated to enable identification of the item listing as being recommended and enabling prioritization or organization of the item listing. The recommendation tag may be understood as a binary tag representing either presence or absence of a recommendation, according to some embodiments. In these instances, the recommendation tag may be flagged, set, encoded, or otherwise included within the data comprising the item listing (e.g., binary or code). The recommendation system 150 can automatically modify the item listing to include the recommendation tag or set the recommendation tag as recommended, based on receiving the recommendation indication in operation 330.

Where the recommendation tag is a set of recommendation data, the recommendation tag may include a plurality of recommendation characteristics relating to the recommendation and one or more conditions or contingencies of the recommendation. For example, the recommendation tag may indicate presence or absence of a recommendation, a relative strength of the recommendation, one or more conditions applicable to the recommendation, a prioritization weight or relative prioritization weight, or any other information suitable to convey a recommendation and aspects of the recommendation to the recommendation system 150.

The relative strength of the recommendation may relate to the presence or absence of conditions to the recommendation, according to some embodiments. Further, the relative strength of the recommendation may increase or decrease based on the conditions. For example, the recommendation may include a first recommendation value indicating a relatively high strength of recommendation for a first price and a second recommendation value indicating a relatively low strength of recommendation for a second price. In some embodiments, the relative strength may include any number of values extending between two limits, embodied by bounds of a condition or contingency.

As previously described, the one or more conditions applicable to the recommendation may be understood as one or more characteristics for which or bounds within which the item listing is recommended by the recommender. For example, the one or more conditions may be a recommendation between a first price and a second price. By way of further example, where the item listing represents a condition dependent item (e.g., a collectible stamp, artwork, or car), the one or more condition may be a recommendation based on a demonstrated characteristic of the item, such as the mileage of a car, edge wear of a stamp or a book, or condition and color of paint on a collectible portrait and a location or existence of a signature.

The prioritization weight may be understood as a value indicative of a weight to apply when prioritizing the item listing among a set of item listings. For example, the prioritization weight may be related to the recommendation strength, the one or more conditions applicable to the recommendation, the expertise of the recommender, the relative expertise of the recommender with respect to other recommenders associated with a given category, or an accuracy rating of the recommender. A stronger recommendation, or fewer conditions, may cause the recommendation system 150 to generate and apply a higher prioritization weight to the item listing.

Prioritization weights may be indicated by placement of the item listing within a set of search results or a user perceivable user interface element. For example, where the prioritization weight is indicated by placement of the item listing, the recommendation system 150 may cause the item listing with the highest prioritization weight to be placed first within an ordered list of item listings. In some embodiments, the prioritization weight may override other organization schemes or be weighted within the organization scheme to achieve the effect of prioritizing the recommended item listing. Where the prioritization weight is indicated by a user perceivable user interface element, the prioritization weight may be translated into a color, size, or placement of a user interface element indicating the item listing has been recommended by a recommender. By way of further example, the prioritization weight may be indicated by a sound, smell, texture, taptic or haptic response, or any other suitable user perceivable indicator.

In operation 350, the presentation module 250 causes presentation of the item listing with a representation of the recommendation tag. As discussed above, the recommendation tag may be implemented within the item listing as a bit or other data modification to the item listing. In some example embodiments, the representation of the recommendation tag is a visible user interface element presented within the item listing in operation 350. By way of example, the recommendation tag may be represented as a user perceivable user interface element such as a color, size, or placement of a visible user interface element, or a non-visual representation such as a sound, smell, taptic or haptic response, or any other user perceivable indicator. In some instances, the representation of the recommendation tag is represented by prioritized placement of the item listing within a set of search results. Similar to the representation of the prioritization weight, the recommendation tag may be represented by a placement of the item listing within an ordered list or other organized search result set.

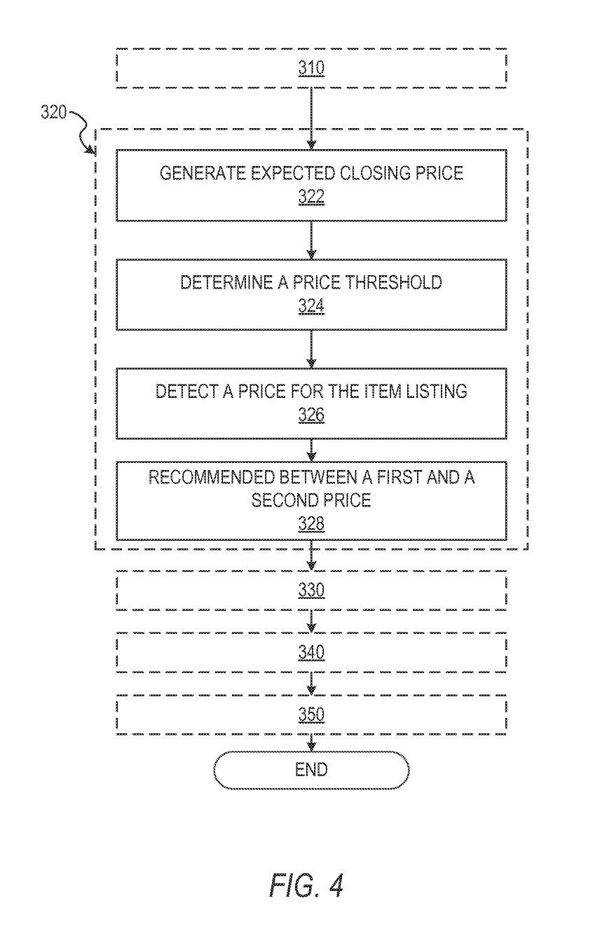

FIG. 4 is a flowchart showing operations included within the operation 320 of determining whether the item listing is a candidate for the recommendation label, according to various example embodiments. The operations depicted in FIG. 4 may be performed by the recommendation system 150, using modules described above with respect to FIG. 2.

In operation 322, the determination module 220 generates an expected closing price for the item listing. The determination module 220 generates the expected closing price for the item listing algorithmically based one or more algorithms or sets of automated machine readable instructions configured to compare the item listing with a set of closed item listings within one or more of the publication system 142 and the third party server 130. The determination module 220 may compare characteristics, features, categories, and other descriptive elements for the item listing and the set of closed item listings to determine one or more matching characteristics, features, categories, and other descriptive elements. After determining matching item descriptions among item listings, the determination module 220 may perform one or more operations to determine a relation between the matching item descriptions and the effect of the matching item descriptions on closing prices of the set of closed item listings. The determination module 220 then extrapolates the expected closing price from the closing prices of the set of closed items based on the matched item descriptions.

In operation 324, the determination module 220 determines a price threshold for the item listing. The price threshold may be understood as a price, below the expected closing price for the item listing, at which the item listing may be recommended. For example, below the price threshold, users, such as the recommender, may determine the item listing to be qualitatively a good deal. The determination module 220 may determine the price threshold based on a comparison of the item listing and the closed item listings having one or more item description elements matching the item listing.

In operation 326, the determination module 220 detects a price for the item listing which is below a predetermined price threshold, such as the price threshold determined in operation 324. The determination module 220 may detect the price for the item listing by parsing the item description data included within the item listing or metadata associated with the item listing.

In operation 328, the recommendation indication received in operation 330 is representative of the item listing being recommended between the first price and the second price, where one or more of the first price and the second price are below the expected closing price of the item listing. In some example embodiments, the recommendation indication is representative of the item listing being recommended between the first price and the second price below the price threshold determined in operation 324.

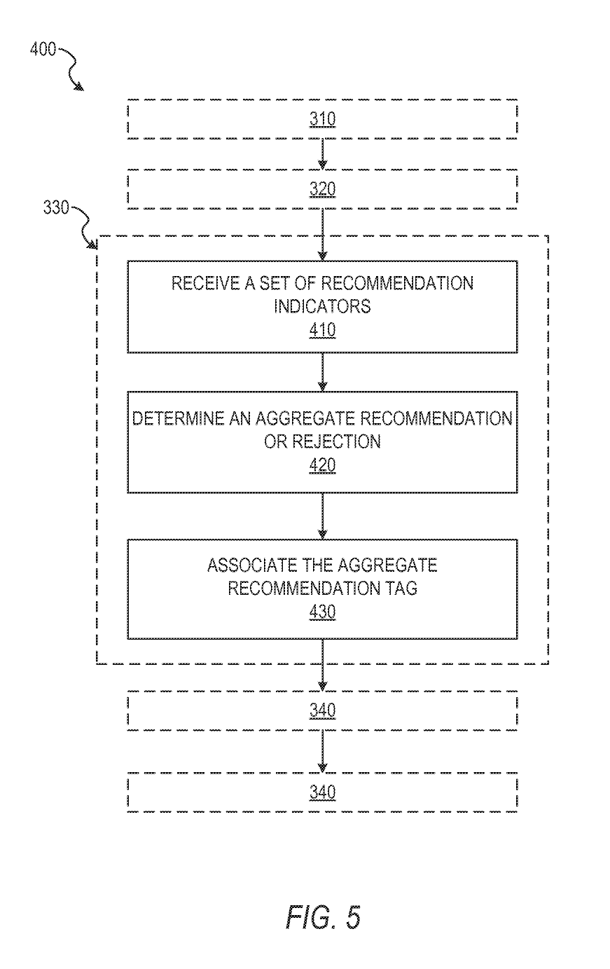

FIG. 5 is a flow chart of operations of the recommendation system 150 in performing a method 400 of automatically ascertaining eligibility of an item listing (e.g., discrete data object) for a recommendation, obtaining a set of recommendations, and causing prioritization and presentation of the item listing based on the recommendation. Operations in the method 400 may be performed by the recommendation system 150, using modules described above with respect to FIG. 2. Further, operation of the method 400 includes one or more of the operations of the method 300, according to some embodiments and as shown in FIG. 5.

In executing the method 400, the recommendation system 150 may initially execute operations 310 and 320. In operation 410, the receiver module 230 receives a set of recommendation indicators from a set of recommenders. Each recommendation indicator represents a recommendation of a single recommender. The recommendation indicators may be implemented similarly or the same as the recommendation indicator described above with respect to the method 300.

In operation 420, the determination module 220 evaluates the set of recommendation indicators from the set of recommenders. The determination module 220 determines whether the set of recommendation indicators represents an aggregate recommendation or an aggregate rejection for the item listing by the set of recommenders. In some example embodiments, the one or more recommendation indicators of the set of recommendation indicators may be weighted based on a relative strength of the recommendation, the relative expertise of the recommender, or the like.

In operation 430, in response to an evaluation of the set of recommendation indicators as representing an aggregate recommendation for the item listing, the association module 240 associates the recommendation tag with the item listing similar to operation 340. After execution of operation 430, in some example embodiments, the recommendation system 150 may execute the operation 350, discussed above.

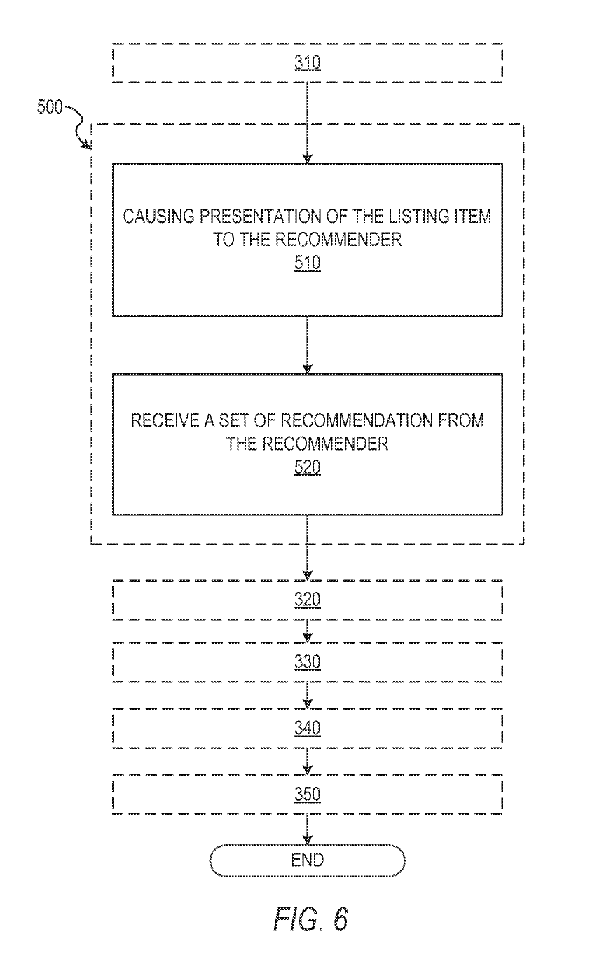

FIG. 6 is a flow chart of operations of the recommendation system 150 in performing a method 500 of facilitating recommendations from recommenders to generate item listings suitable for recommendation. Operations of the method 500 may be performed by the recommendation system 150, using modules described above with respect to FIG. 2. In some example embodiments, as shown in FIG. 6, the method 500 includes one or more operations of the method 300. As shown, the method 500 is initially performed by executing the operation 310.

In operation 510, the presentation module 250 causes presentation of the item listing to the recommender. According to some example embodiments, the item listing comprises the item description and one or more user interface elements configured to receive recommendations associated with one or more characteristics of the item listing and the item description.

In operation 520, the receiver module 230 receives a set of recommendations from the recommender. The set of recommendations comprising one or more pricing recommendations and one or more item description recommendations. For example, the recommender, being determined to be an expert within a given category of the item listing, may include pricing recommendations suitable to qualitatively suggest the item listing is a good deal. In this example, the recommender may additionally suggest additions or deletions to the item description, such as including images or description of certain aspects of the item (e.g., a liner included in a collectible antique hat, a condition of a vintage coin, foxing around the edges of a collectible stamp or book, etc.).

Once the set of recommendations have been received, the recommendation system 150 may execute the operations 320-350. In some example embodiments, the recommendation system 150 requires action to be taken on the item listing in response to the set of recommendations prior to performing the operations 320-350.

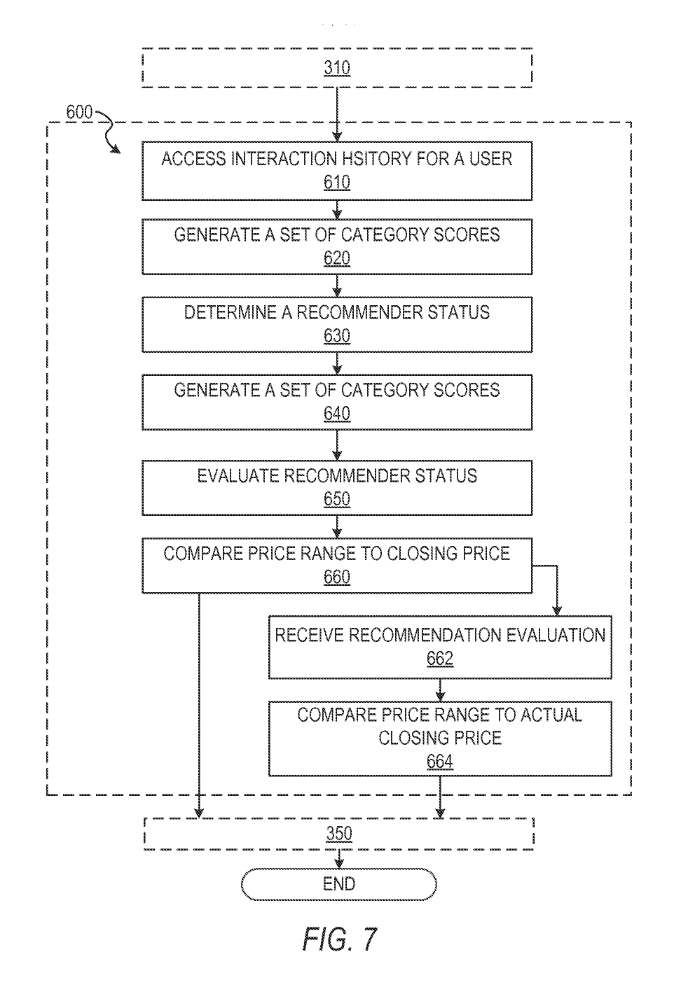

FIG. 7 is a flow chart of operations of the recommendation system 150 in performing a method 600 of automatically ascertaining eligibility of an item listing for a recommendation from a recommender and automatically determining a recommender status for the recommender based on a detection of a suitable expertise level. The recommender may be understood as a user of the publication system 142 determined by the recommendation system 150 to have the suitable expertise level, as discussed in more detail below. Operations of the method 600 may be performed by the recommendation system 150, using modules described above with respect to FIG. 2. In some embodiments, as shown in FIG. 7, the method 600 includes one or more operations of the method 300. For example, as shown, the method 600 is initially performed by executing the operation 310.

In operation 610, the access module 210 accesses an interaction history of a user (e.g., user 106). The interaction history comprises a set of interactions with one or more of the publication system 142, the third party system 130, and the recommendation system 150. Each interaction within the set of interactions is associated with one or more item listings and one or more item listing categories.

In operation 620, the determination module 220 generates a set of category scores for the user for the item listing categories associated with the set of interactions. The set of category scores are discussed in more detail below, however, the set of category scores may be understood as quantitative representations of a level of expertise within a given item listing category or set of related item listing categories.

In operation 630, the determination module 220 determines a recommender status based on at least one category score of the set of category scores. In some example embodiments, the recommender status is based on the at least one category score exceeding a predetermined score threshold. In some embodiments, the predetermined score threshold may be static and determined by the recommendation system 150. In some instances, the predetermined score threshold is variable and may be understood to be a function of an evaluation of the category scores of users having previously been granted recommender status.

In operation 640, the association module 240 associates a recommender status tag with the user. The recommender status tag is representative of the determination of the recommender status for the user with respect to the item listing category for which the category score exceeds the predetermined score threshold. In embodiments where operation 640 has been performed, the association of the recommender status tag with the user, thereby granting recommender status to the user, enables the recommendation system 150 to cause presentation of a recommendation indicator to a client device 110 associated with the user (e.g., the newly granted recommender). Presentation of the recommendation indicator to the recommender may be understood as a precursor to operation 330 of receiving the recommendation indication for the item listing. Further, in some embodiments, the presentation of the recommendation indicator enables the receiver module 230 to receive a selection of the recommendation indicator from the recommender, as part of operation 330.

The recommender status tag may be understood as a bit, collection of bits, code portion, executable instruction, or other portion of the user profile of the recommender manipulated to authorize access for being presented with recommendation indicators requested for item listings. In some embodiments, the recommender status tag may be understood as a binary tag representing either presence or absence of a recommender status. In some example embodiments, the recommender status tag comprises a set of recommender data. For example, the recommender status tag may indicate the presence or absence of a recommender status, a relative level of expertise, a set of categories for which recommender status has been granted, a number of recommendations available within a given period of time, a number of recommendations given, an accuracy ranking for the recommendations given, and other suitable recommender status data indicative of the present recommender status and historical interactions performed under the auspices of the recommender status.

The recommender status, represented by the recommender status tag, may be evaluated automatically by the recommendation system 150. In some example embodiments, in operation 650, the determination module 220 automatically evaluates the recommender status of the user based on the recommender's recommendations or third party reviews of the recommender's recommendations.

In operation 660, in instances where the recommendation system 150 evaluates the recommender status directly on the recommender's recommendations, recommendations may be contingent on a price range indicator, such as an indication of the first price range and the second price range, discussed above. The determination module 220 automatically evaluates the recommender status by comparing the price range indicator to the expected closing price for the item listing. In some embodiments, where the recommendation system 150 has determined a price threshold for the item listing as a suggested qualitative indication of a good deal, the determination module 220 compares the price range indicator of the recommendation with the price threshold for the item listing. In some embodiments, where the item listing has closed and contains an actual closing price, the determination module 220 compares the price range indicator of the recommendation with the actual closing price. The determination module 220 may compare the values described above to determine whether all or a portion of the price range represented by the price range indicator exceeds the expected closing price, the price threshold, and the actual closing price to determine the recommender's accuracy in evaluating closing prices of item listings and qualitatively good deals. Where the price range falls below or within a suitable range of one or more of the expected closing price, the price threshold, and the actual closing price, the determination module 220 may verify the recommender status or use the above comparisons as input for evaluating the recommender status.

Where the recommendation system 150 evaluates and verifies the recommender status, no further action may be taken with respect to the recommender status tag in the recommender's user profile. Where the recommendation system 150 evaluates the recommender status and determines the recommendations of the recommender warrant removal of the recommender status, the recommendation system 150 may automatically modify the user profile of the recommender, removing or disabling the recommender tag from the user profile. In some embodiments, an evaluation warranting removal of the recommender status may generate a system interrupt causing a temporary cessation of one or more operations of the recommendation system 150 and interactions of the recommender within the recommendation system 150 and the publication system 142. The system interrupt may enable the recommendation system 150 to remove the recommender status while preventing the user from performing recommendation actions during the removal process. Similarly, the system interrupt may enable the recommendation system 150 to retract pending or established recommendations of the recommender within item listings stored within the publication system 142 or the third party server 130.

In operation 660, in example embodiments where the recommendation system 150 evaluates the recommender status based on third party reviews of the recommender's recommendations, recommendations may be contingent on a price range indicator, such as an indication of the first price range and the second price range, discussed above. The receiver module 230 receives a recommendation evaluation from a buyer of the item listing recommended by the recommender, in operation 662. The recommendation evaluation may be generated and received after closing of the item listing. In some example embodiments, the recommendation evaluation comprises a quantitative evaluation of the recommendation with respect to the actual closing price of the item listing and a qualitative evaluation from the buyer as to whether the buyer considers one or more of the actual closing price and the recommendation to be a good deal.

In operation 664, the determination module 220 evaluates the recommender status by comparing the price range indicator to the actual closing price of for the item listing, similar to the comparison outlined above with respect to operation 650. The determination module 220 also evaluates the recommender status based on recommendation evaluation from the buyer.

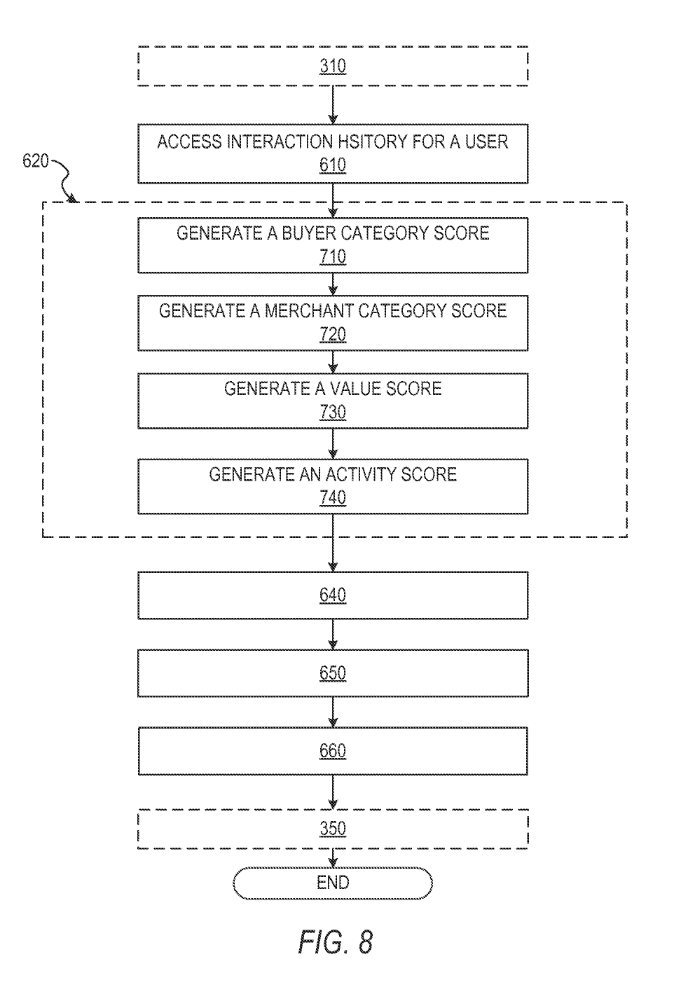

FIG. 8 is a flow chart showing operations included within the operation 620 of generating the set of category scores, according to various example embodiments. The operations depicted in FIG. 8 may be performed by the recommendation system 150, using modules described above with respect to FIG. 2.

In operation 710, the determination module 220 generates a buyer category score representative of a number of item listings purchased within a given item listing category. The buyer category score may be generated based on one or more of the number of item listings purchased, the frequency of purchasing of item listings within the given category, the recency of purchases of the item listings, the length of history of purchasing item listings within the given category, the purchase of item listings in related (e.g., parent or subordinate) categories, and other suitable information sources. The buyer category score may also include weighting of item listings purchased for closing prices determined to be below expected closing prices for similar items.

In operation 720, the determination module 220 generates a merchant category score representative of a number of item listings sold within the given item listing category. Similar to the generation of the buyer category score, the merchant category score may be generated based on one or more of the number of item listings sold, the frequency of selling of item listings within a given or related category, the recency of selling of item listings within the given or related category, the length of history of selling item listings within the given or related category, the sale of item listings in related (e.g., parent or subordinate) categories, and other suitable information sources.

In operation 730, the determination module 220 generates a value score indicative of a representative spread between closing prices of a set of purchased item listings and a set of resold item listings. In some example embodiments, at least a portion of the set of resold item listings are originally a portion of the set of purchased item listings, where the user is reselling items previously purchased within the set of purchased item listings.

In operation 740, the determination module 220 generates an activity score representative of a number of item listing categories having a number of interactions exceeding a predetermined interaction threshold. The activity score may be generated based on the breadth of item listing categories with which the recommender interacts. For example, where the recommender interacts with only or primarily a set of related categories, the determination module 220 may generate a higher activity score than generated for a recommender active in a broad base of unrelated categories.

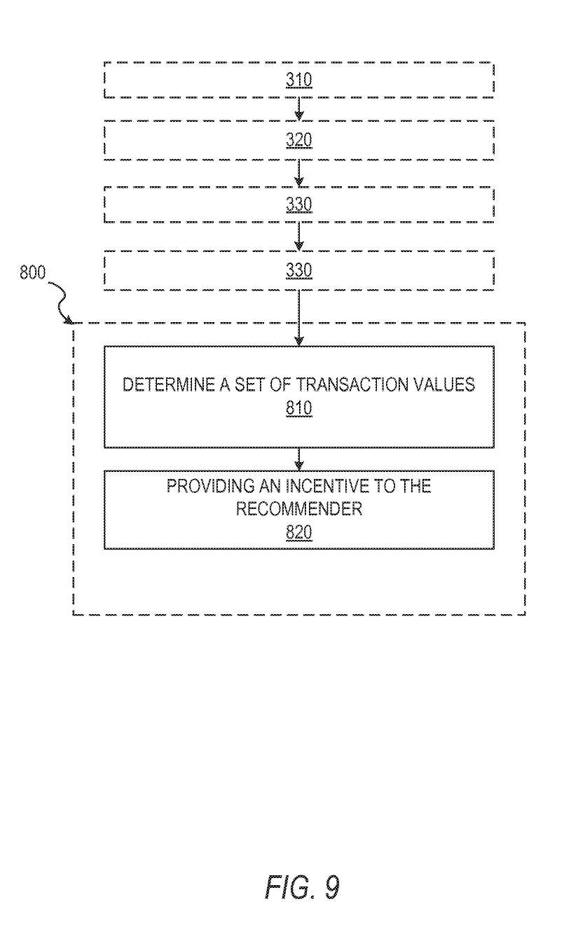

FIG. 9 is a flow chart showing operations of a method 800 of automatically ascertaining eligibility of an item listing for a recommendation and incentivizing the recommender for recommendations provided and to provide further recommendations. Operations of the method 800 may be performed by the recommendation system 150 using modules described above with respect to FIG. 2. In some example embodiments, the recommendation system 150 may perform one or more operations of the method 800 in conjunction with the publication system 142 and the payment system 144. In some embodiments, as shown in FIG. 9, the method 800 includes one or more operations of the method 300. For example, as shown, the method 800 is initially performed by executing operations 310-340.

In operation 810, the determination module 220 determines a set of transaction values associated with a set of recommendation indications of the recommender. The transaction values may be determined based on a comparison of closing prices of item listings similar to the item listings associated with the set of recommendation indications. In this example, the transaction values may be an incremental increase in the price or a lowered time period between storing the item listing on the publication system 142 and sale of the item listing.

In operation 820, based on receiving the set of recommendation indications, the presentation module 250 providing an incentive to the recommender. In some example embodiments, the incentive is a portion of the set of transaction values associated with the set of recommendation indications. The portion of the set of transaction values may be transmitted to an account associated with the user profile of the recommender by the payment system 144 and one or more user interface elements indicative of the incentive is presented to the recommender by the presentation module 250. In some instances, the presentation module 250 causes presentation of a user interface element indicative of the incentive, such as a coupon associated with the publication system 142.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., at least one processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by at least one processor that is temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-9 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

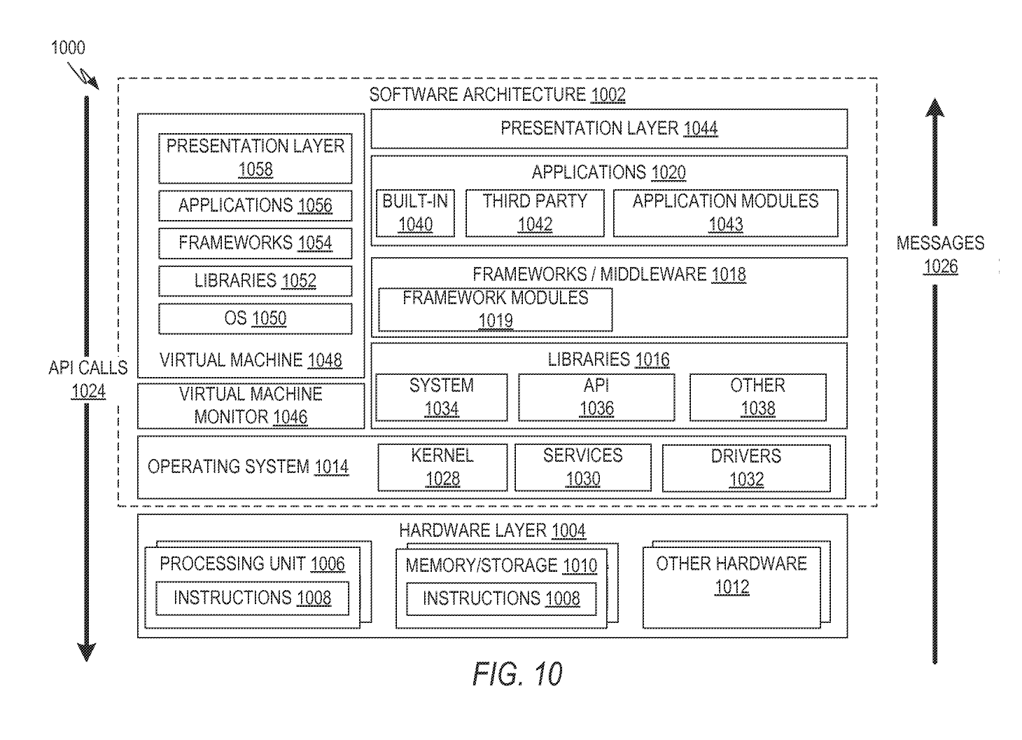

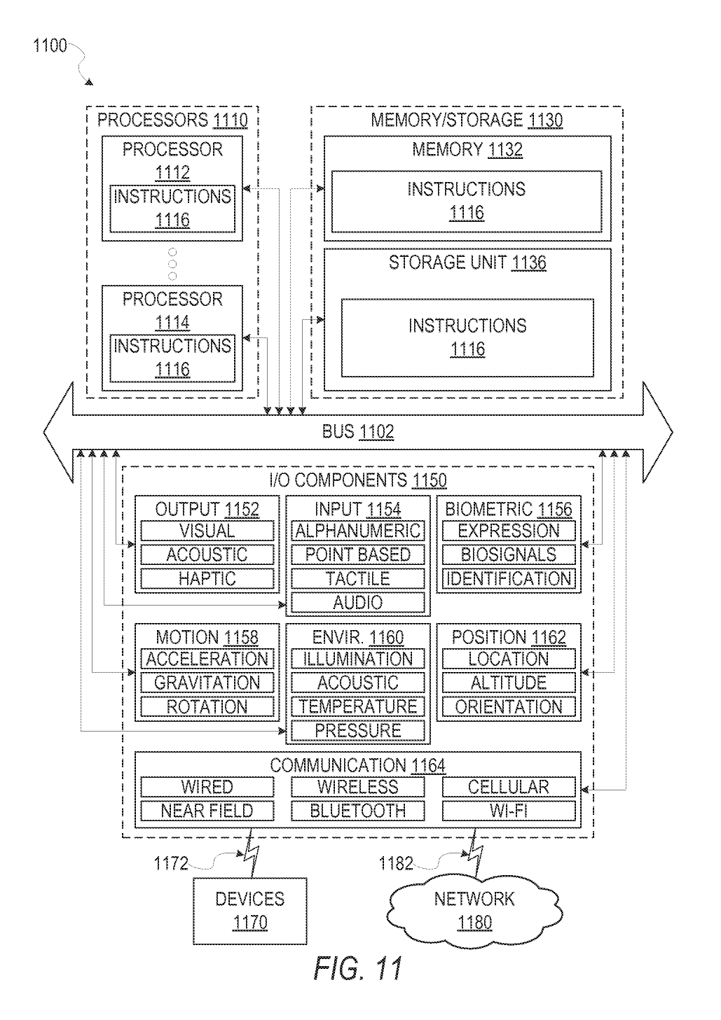

FIG. 10 is a block diagram 1000 illustrating a representative software architecture 1002, which may be used in conjunction with various hardware architectures herein described. FIG. 10 is merely a non-limiting example of a software architecture and it will be appreciated that many other architectures may be implemented to facilitate the functionality described herein. The software architecture 1002 may be executing on hardware such as machine 1100 of FIG. 11 that includes, among other things, processors 1110, memory 1130, and I/O components 1150. A representative hardware layer 1004 is illustrated and can represent, for example, the machine 1100 of FIG. 11. The representative hardware layer 1004 comprises one or more processing units 1006 having associated processor executable instructions 1008. Executable instructions 1008 represent the executable instructions of the software architecture 1002, including implementation of the methods, modules and so forth of FIGS. 1-9. Hardware layer 1004 also includes memory and/or storage modules 1010, which also have executable instructions 1008. Hardware layer 1004 may also comprise other hardware as indicated by 1012 which represents any other hardware of the hardware layer 1004, such as the other hardware illustrated as part of machine 1100.

In the example architecture of FIG. 10, the software 1002 may be conceptualized as a stack of layers where each layer provides particular functionality. For example, the software 1002 may include layers such as an operating system 1014, libraries 1016, frameworks/middleware 1018, applications 1020 and presentation layer 1022. Operationally, the applications 1020 and/or other components within the layers may invoke application programming interface (API) calls 1024 through the software stack and receive a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1016 may provide a common infrastructure that may be utilized by the applications 1020 and/or other components and/or layers. The libraries 1016 typically provide functionality that allows other software modules to perform tasks in an easier fashion than to interface directly with the underlying operating system 1014 functionality (e.g., kernel 1028, services 1030 and/or drivers 1032). The libraries 1016 may include system 1034 libraries (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks 1018 (also sometimes referred to as middleware) may provide a higher-level common infrastructure that may be utilized by the applications 1020 and/or other software components/modules. For example, the frameworks 1018 may provide various graphic user interface (GUI) functions, high-level resource management, high-level location services, and so forth. The frameworks 1018 may provide a broad spectrum of other APIs that may be utilized by the applications 1020 and/or other software components/modules, some of which may be specific to a particular operating system or platform.

The applications 1020 includes built-in applications 1040, third party applications 1042, application modules 1043. Examples of representative built-in applications 1040 may include, but are not limited to, a contacts application, a browser application, a book reader application, a location application, a media application, a messaging application, and/or a game application. Third party applications 1042 may include any of the built in applications as well as a broad assortment of other applications. In a specific example, the third party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 1042 may invoke the API calls 1024 provided by the mobile operating system such as operating system 1014 to facilitate functionality described herein. The application modules 1043 may be application layer portions of the modules 210-250.

The applications 1020 may utilize built in operating system functions (e.g., kernel 1028, services 1030 and/or drivers 1032), libraries (e.g., system 1034, APIs 1036, and other libraries 1038), frameworks/middleware 1018 to create user interfaces to interact with users of the system. In some example embodiments, portions of the modules 210-250 may be implemented in the frameworks/middleware 1018 layer to perform operations for the recommendation system 150 at the framework/middleware layer. Alternatively, or additionally, in some systems interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware machine (such as the machine of FIG. 11, for example). A virtual machine is hosted by a host operating system (operating system 1014 in FIG. 11) and typically, although not always, has a virtual machine monitor 1046, which manages the operation of the virtual machine as well as the interface with the host operating system (i.e., operating system 1014). A software architecture executes within the virtual machine such as an operating system 1050, libraries 1052, frameworks/middleware 1054, applications 1056 and/or presentation layer 1058. These layers of software architecture executing within the virtual machine 1048 can be the same as corresponding layers previously described or may be different.

### Example Machine Architecture and Machine-Readable Medium

FIG. 11 is a block diagram illustrating components of a machine 1100, according to some example embodiments, able to read instructions from a machine-readable medium (e.g., a non-transitory machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions may cause the machine to execute the flow diagrams of FIGS. 3-9. Additionally, or alternatively, the instructions may implement at least a portion of the access module 210, the determination module 220, the receiver module 230, the association module 240, the presentation module 250, and the communication module 260 of FIGS. 2-9, and so forth. It should be understood that portions of the instructions implementing the modules described above may be distributed across separate machines, thereby implementing one or more portions of any given module across more than one machine. The instructions transform the general, non-programmed machine into a particular machine programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), an entertainment media system, a cellular telephone, a smart phone, a mobile device, a wearable device (e.g., a smart watch), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the 1/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method, comprising:
accessing an item listing including an item description;
determining, by at least one processor of a machine, the item listing is a candidate for a recommendation label;
receiving a recommendation indication for the item listing, the recommendation indication representing a recommendation for the item listing between a first price and a second price;
in response to the recommendation indication, associating a recommendation tag with the item listing; and
causing presentation of the item listing with a representation of the recommendation tag.

2. The method of claim 1, wherein determining the item listing is a candidate for the recommendation label further comprises:
generating an expected closing price for the item listing;
determining a price threshold for the item listing, the price threshold being below the expected closing price for the item listing; and
detecting a price for the item listing is below a predetermined price threshold.

3. The method of claim 2, wherein the recommendation indication being representative of the item being recommended between a first price and a second price below the expected closing price for the item listing.

4. The method of claim 1, wherein the recommendation tag is a visible user interface element presented within the item listing.

5. The method of claim 1, wherein the recommendation tag is represented by prioritized placement of the item listing within a set of search results.

6. The method of claim 1, wherein the recommendation indication is received from a recommender, the recommender being a user, and receiving the recommendation indication further comprises:
accessing an interaction history of the user, the interaction history including a set of interactions with each interaction of the set of interactions being associated with an item listing category;
generating a set of category scores for the item listing categories associated with the set of interactions;
determining a recommender status based on at least one category score of the set of category scores exceeding a predetermined score threshold; and
associating a recommender status tag with the user, the recommender status tag being representative of the determination of the recommender status with respect to the item listing category for which the category score exceeds the predetermined score threshold.

7. The method of claim 6, wherein generating the set of category scores further comprises:
generating a buyer category score representative of a number of item listings purchased within the item listing category;
generating a merchant category score representative of a number of item listings sold within the item listing category;
generating a value score indicative of a representative spread between a set of purchased item listings and a set of resold item listings; and
generating an activity score representative of a number of item listing categories having a number of interactions exceeding a predetermined interaction threshold.

8. The method of claim 6, wherein receiving the recommendation indication further comprises:
based on the association of the recommender status tag with the user, causing presentation of a recommendation indicator to a client device associated with the user; and
receiving a selection of the recommendation indicator.

9. The method of claim 8, wherein the recommendation indicator includes a price range indicator and further comprising:
automatically evaluating the recommender status of the user by comparing the price range indicator to an expected closing price for the item listing and a price threshold for the item listing, the price threshold being below the expected closing price for the item listing and comparing an actual closing price for the item listing with the price range indicator.

10. The method of claim 8, wherein the recommendation indicator includes a price range indicator and further comprising:
receiving a recommendation evaluation from a buyer of the item listing after closing of the item listing; and
evaluating the recommender status by comparing the price range indicator to an actual closing price for the item listing and the recommendation evaluation from the buyer.

11. The method of claim 6, further comprising:
determining a transaction value of a set of recommendation indications of the recommender; and
based on receiving the set of recommendation indications, providing an incentive to the recommender.

12. The method of claim 1, wherein receiving the recommendation indication further comprises:
receiving a negative recommendation indication for the item listing, the negative recommendation indication representing a rejection of the item listing between the first price and the second price.

13. The method of claim 1, wherein receiving the recommendation indication for the item listing further comprises:
receiving a set of recommendation indicators from a set of recommenders, each recommendation indicator being representative of a recommendation of a single recommender;
evaluating the set of recommendation indicators as representing an aggregate recommendation for the item listing by the set of recommenders; and
in response to the evaluation of the set of recommendation indicators, associating the recommendation tag with the item listing.

14. The method of claim 1 further comprising:
causing presentation of the item listing to a recommender, the presentation of the item listing including the item description and one or more user interface element configured to receive recommendations associated with one or more characteristics of the item description; and
receiving a set of recommendations from the recommender, the set of recommendations including one or more pricing recommendations and one or more item description recommendations.

15. A system, comprising:
an access module to access an item listing including an item description;
a determination module to determine the item listing is a candidate for a recommendation label;
a receiver module to receive a recommendation indication for the item listing, the recommendation indication representing a recommendation for the item listing between a first price and a second price;
an association module to associate a recommendation tag with the item listing in response to the recommendation indication; and
a presentation module to cause presentation of the item listing with a representation of the recommendation tag.

16. The system of claim 15, wherein the determination module is further configured to generate an expected closing price for the item listing, determine a price threshold for the item listing, and detect a price for the item listing is below a predetermined price threshold, the price threshold being below the expected closing price for the item listing.

17. The system of claim 16 further comprising:
the access module configured to access an interaction history of a user, the interaction history including a set of interactions with each interaction of the set of interactions being associated with an item listing category;
the determination module configured to generate a set of category scores for the item listing categories associated with the set of interactions and to determine a recommender status for the user based on at least one category score of the set of category scores exceeding a predetermined score threshold; and
the association module configured to associate a recommender status tag with the user, the recommender status tag being representative of the determination of the recommender status with respect to the item listing category for which the category score exceeds the predetermined score threshold.

18. The system of claim 16 further comprising:
the receiver module configured to receive a set of recommendation indicators from a set of recommenders, each recommendation indicator being representative of a recommendation of a single recommender;
the determination module configured to evaluate the set of recommendation indicators as representing an aggregate recommendation for the item listing by the set of recommenders; and
the association module configured to associate the recommendation tag with the item listing in response to the evaluation of the set of recommendation indicators.

19. A non-transitory machine-readable storage medium comprising processor executable instructions that, when executed by a processor of a machine, cause the machine to perform operations comprising:
accessing an item listing including an item description;
determining, by at least one processor of a machine, the item listing is a candidate for a recommendation label;
receiving a recommendation indication for the item listing, the recommendation indication representing a recommendation for the item listing between a first price and a second price;
in response to the recommendation indication, associating a recommendation tag with the item listing; and
causing presentation of the item listing with a representation of the recommendation tag.

20. The non-transitory machine-readable storage medium of claim 19, wherein determining the item listing as a candidate for the recommendation label includes operations further comprising:
generating an expected closing price for the item listing;
determining a price threshold for the item listing, the price threshold being below the expected closing price for the item listing; and
detecting a price for the item listing is below a predetermined price threshold.
